(19) United States
(12) Patent Application Publication
(10) Pub. No.: US 2006/0175424 A1
(43) Pub. Date: Aug. 10, 2006

(54) Modular fountain housing and fountain system

(76) Inventors: Preston A. Tatum, Martindale, TX (US); Kevin T. Brown, Austin, TX (US); David D. Pena, New Braunfels, TX (US); Ronn F. Phillips, San Marcos, TX (US); James M. Souza, New Braunfels, TX (US); David R. Tinney, Kyle, TX (US); Robert F. Gaertner, Kingsbury, TX (US); Kenneth L. Krauskopf, San Marcos, TX (US)

Correspondence Address: Ronald B. Sefrna, P.O. Box 567, Tyler, TX, 75710, US

(21) Appl. No.: 11/327,841

(22) Filed: Jan. 9, 2006

Related U.S. Application Data
(60) Provisional application No. 60/647,098, filed on Jan. 26, 2005.

(51) Int. Cl. F21S 8/00

(52) U.S. Cl. 239/18; 239/16

(57) ABSTRACT

A modular system for, especially, dry basin fountain installations includes a housing having a water supply inlet, a drain outlet, an electrical supply inlet and electrical junction box, for removable and interchangeable installation of a variety of individual or multiple fountain components within each housing, including water jet assemblies, lighting assemblies, and audio speakers, for supplying water to and draining water from each housing to a water reservoir, and for controlling the operation of each fountain component. Water supply lines, drain lines, and electrical lines may be routed between all housings and a water reservoir and an electrical supply center, so that fountain components may be installed, removed, and exchanged without disturbing the surface in which the fountain is installed.

### RELATED APPLICATION DATA

This application claims the priority of U.S. Provisional Patent Application Ser. No. 60/647,098, filed Jan. 26, 2005, titled “Modular Fountain Housing And Fountain System”.

### FIELD OF THE INVENTION

The present invention generally relates to decorative and interactive water fountains, and in its preferred embodiments more specifically relates to modular fountain component housing apparatus and methods of use to facilitate the installation, maintenance, expansion, and modification of large scale decorative water fountain displays.

### BACKGROUND OF THE INVENTION

Decorative and interactive water fountains have long been an important aesthetic element in both public and private landscape and hardscape areas. In recent years some fountain systems have become quite elaborate, and it is not uncommon for modern fountain displays to incorporate features such as timed water effect jets, lights of various colors, and sound. As fountains have become more elaborate, the initial installation and maintenance, as well as expansion and modification of existing fountains, has become correspondingly complex.

One type of fountain that has become popular is known as a dry fountain or hidden basin fountain. In that type of fountain installation the basin or pool reservoir from which water is pumped to the fountain water effect jets is located below pavement grade level, and the fountain jets are positioned at grade level in an expanse of paving. Often, the paving is supported on a structural framework grid system that covers the water reservoir. Water emitted from the fountain water effect jets falls back onto the paving and drains into the basin through a drain system incorporated into the paving. In the conventional approach, each water jet, as well as each lighting fixture and/or sound speaker is disposed in the paving, all independently.

In a variation of the platform or grid type hidden basin fountain design, a below ground tank or similar structure is used as the water reservoir from which water is pumped to the fountain water effect jets and to which the drain system is connected. In this approach the paving may be laid on grade, or directly on the ground surface, with independent fountain water effect jets, light fixtures, and sound speakers embedded in the paving.

In all approaches to the construction of dry or hidden basin fountain systems known in the prior art, each fountain water effect jet, each light fixture, each speaker, each drain, etc. is independently placed. Piping, tubing, or cable must be run to each component independently of each other, making the layout and installation an elaborate, time consuming, and thus very costly process. Maintenance of existing prior art fountain systems is also time consuming and costly, especially when component replacement is required. Modification of an existing prior art dry basin fountain system is an equally cumbersome and expensive proposition. If, for example, more lighting is to be added to enhance the fountain display, new light fixtures must be placed, and new wiring must be run to each new fixture, which requires placing new conduit or cable. The same problem is faced if, for example, additional sound speakers are to be placed. With prior art systems, such modifications require disturbing existing paving to place the components and connections in and around the fountain area, and then repairing the paving when the component installation is complete.

### SUMMARY OF THE INVENTION

The present invention provides a modularized system of dry basin fountain components, with component enclosures, or housings, designed to receive a variety of fountain elements, such as fountain water effect jets, valves, light fixtures, electrical connection boxes, and sound speakers, individually or in various combinations. A drain system is incorporated into each housing as well, eliminating the need to place separate, often unsightly, drain inlets in the fountain area. The modular component system of the invention, by allowing the combination of fountain elements in multi-purpose housings, greatly facilitates the installation of a dry basin fountain, minimizes the number of elements that must be installed in the paving, and both minimizes the number of and simplifies the routing of water supply and drain lines and electrical conduit or cable.

The structure and features of the modular housings and the dry basin fountain system of the invention will be described in detail below, with reference to the accompanying drawings and illustrations.

### BRIEF DESCRIPTION OF THE DRAWINGS AND ILLUSTRATIONS

FIG. 1 is a schematic illustration of a basic embodiment of the enclosure housing of the invention with an illustrative combination of fountain components installed therein.

FIG. 2 is an illustration of a nested embodiment of the housing of the invention, with fountain components installed, illustrating the nesting of two housing structures.

FIG. 3 is an illustration of another nested embodiment of the housing of the invention, including three housing structures, one of which is pressurized.

FIG. 4 is an illustration of a basic embodiment of the housing of the invention with water effect nozzles and a sound speaker installed therein.

FIG. 5 illustrates a variety of housing configurations within the scope of the invention.

FIG. 6 is an illustration of a typical nested housing with a cover and concrete anchors.

FIG. 7 is a schematic illustration of a fountain installation laid out in accordance with the system of the invention.

FIG. 8 is a schematic plan view of an illustrative fountain layout utilizing the system of the invention.

### DESCRIPTION OF THE INVENTION

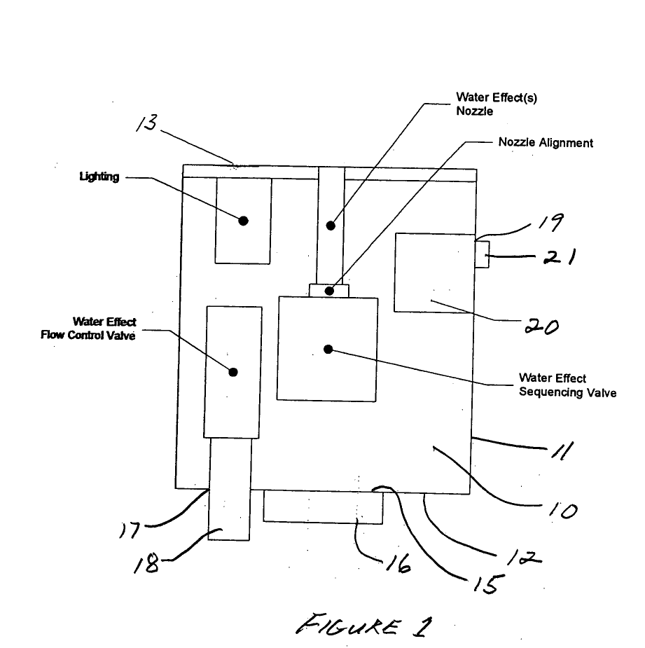

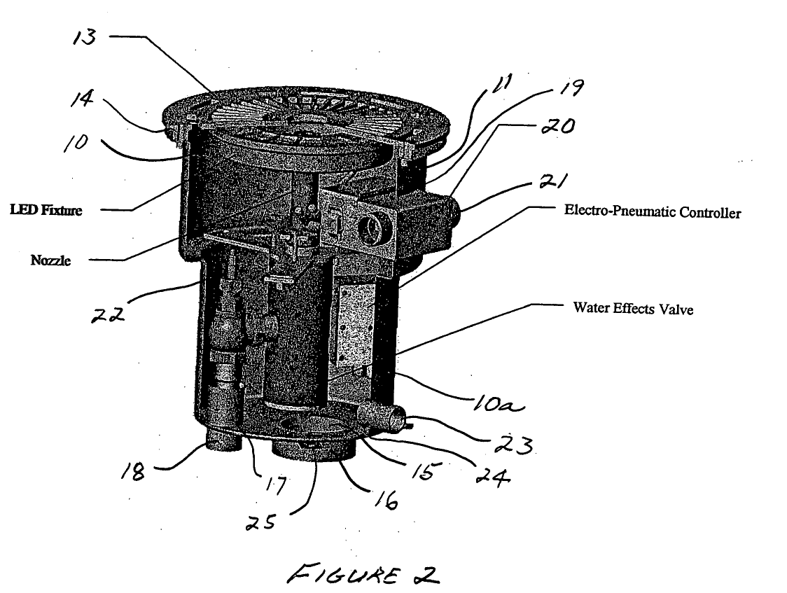

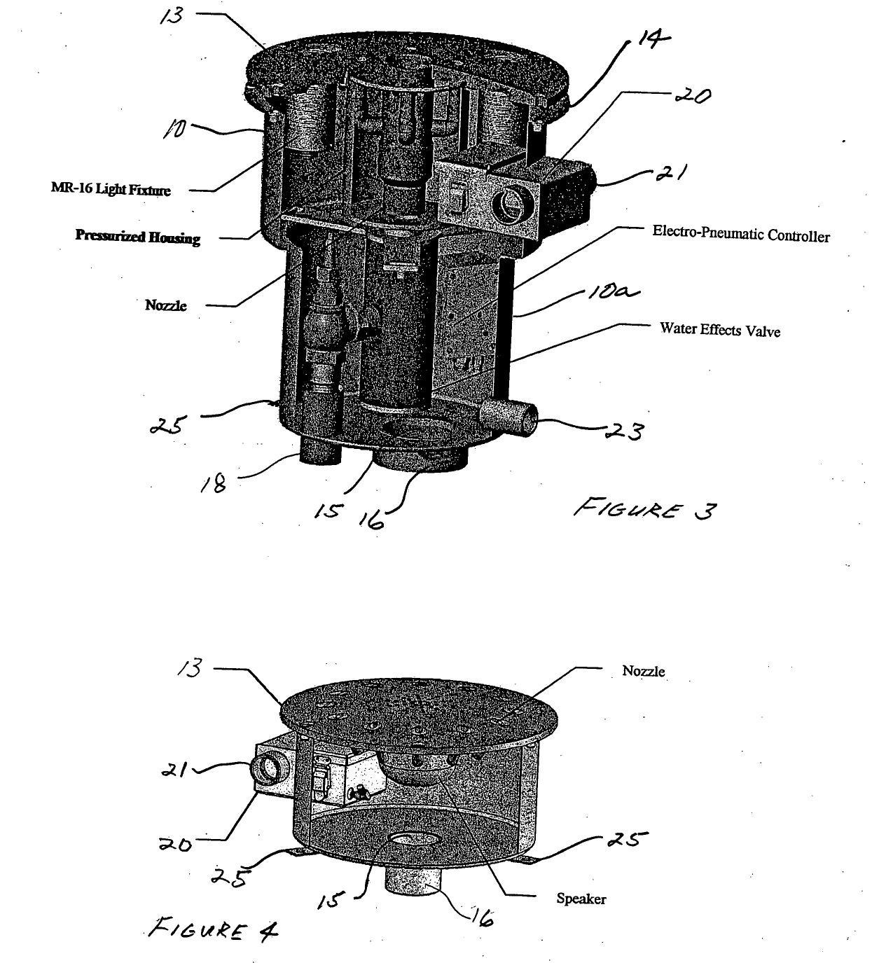

Referring now to the drawing figures and illustrations, the basic embodiment of the housing of the invention, generally identified by reference number 10, is shown in FIG. 1. Housing 10 is preferably configured as, but not limited to, a cylindrical body with a sidewall 11, a bottom closure 12, and an open top. The top of the housing is closed by a removable cover 13, which may be provided in a variety of configurations, depending upon the fountain elements that are installed in a particular housing. An annular lip 14 extends fully around the upper edge of sidewall 11 and a short distance outwardly therefrom, for securing cover 13 to the housing body. Lip 14 also facilitates connection of nested housings, described below. In the basic housing bottom closure 12 is penetrated by a drain aperture 15, which may be surrounded by a nipple 16 for connection of drain piping, and is also penetrated by a water supply aperture 17. A water supply nipple 18 may be connected in aperture 17 if desired. Sidewall 11 is penetrated by an electrical aperture 19 near the upper edge of the sidewall, and an electrical junction box 20 is connected to the inner surface of the sidewall, within the interior of the housing, over the electrical aperture. An electrical conduit nipple 21 preferably extends from junction box 20 through aperture 19 and is connected to the sidewall of the housing. Although nipples 16, 18, and 21 are disclosed as present in the preferred embodiment, it is to be understood that the housing may be provided without one or more of them permanently attached, if appropriate for the manner in which the respective connections to the housing will be made in a particular installation. Further, as shown in FIGS. 2 and 3, junction box 20 may itself be disposed partially through a larger aperture 19, if a larger junction box is needed to provide more space for wiring connections.

FIG. 1 also shows illustrative fountain elements that may be installed in the housing of the invention. The elements included in the figure, i.e., a water flow control valve, a water effects nozzle and sequencing valve, and a lighting fixture, are typical elements that may be installed in a single housing, but are not intended to be limiting of the range and variety of elements that can be used.

As shown in FIGS. 2 and 3, housings of the invention may be constructed in a nested configuration, in which a large bottom aperture 22 is formed in bottom closure 12 of a first housing 10, and a second housing 10a, of smaller diameter, is inserted through the bottom aperture of the first housing in coaxial alignment with the first housing and connected therein with the upper edge of the sidewall of the second housing aligned with the bottom closure of the first housing. The nested configuration increases the depth and volume of the combined housing structure to facilitate the placement of additional or larger fountain elements within the housing. In the installation shown in FIG. 2 an electro-pneumatic controller is added to the elements shown in FIG. 1, and a LED fixture is used for lighting. A conduit 23 serving the electro-pneumatic controller extends through an aperture 23 in housing 10a.

In the illustration of FIG. 3, a third housing 10b is positioned in coaxial alignment with housings 10 and 10a, disposed within the interior of first housing 10. In this configuration housing 10b is a pressurized housing, used to achieve certain water effects.

A further variation in the installations that can be made using the housing system of the invention is shown in FIG. 4, in which a circular nozzle array is positioned to surround a centrally positioned sound speaker in housing 10, to provide water effects and sound to the overall fountain display.

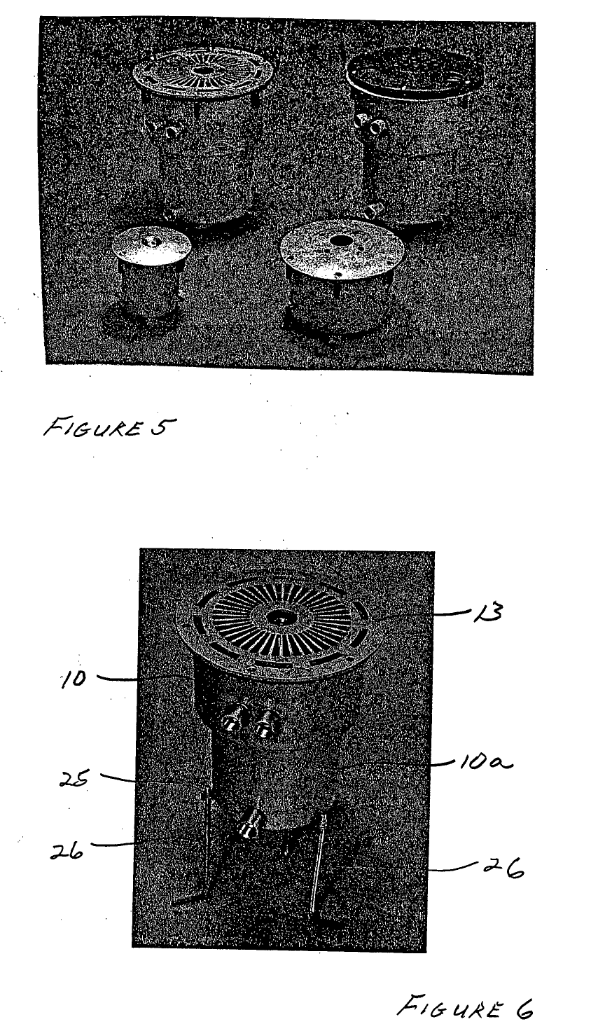

A group of housing is shown in FIG. 5, to provide a non-limiting example of the variety of housing and fountain element configurations that may be provided within the scope of the invention. It will be understood from these illustrative examples that the housing system of the invention enables an unprecedented level of flexibility in the design of fountains, and allows a designer to provide a much more extensive collection of fountain effects within a given project budget than could be achieved with prior art fountain equipment. As a corollary, use of the housing system of the invention allows a given fountain design to be implemented at a significantly lower cost than could be achieved with prior art equipment. It will also be understood that the housing system of the invention improves access to the fountain elements disposed in the housings, greatly facilitating maintenance. Modification of fountain effects by replacement of existing fountain elements with different elements is also greatly facilitated.

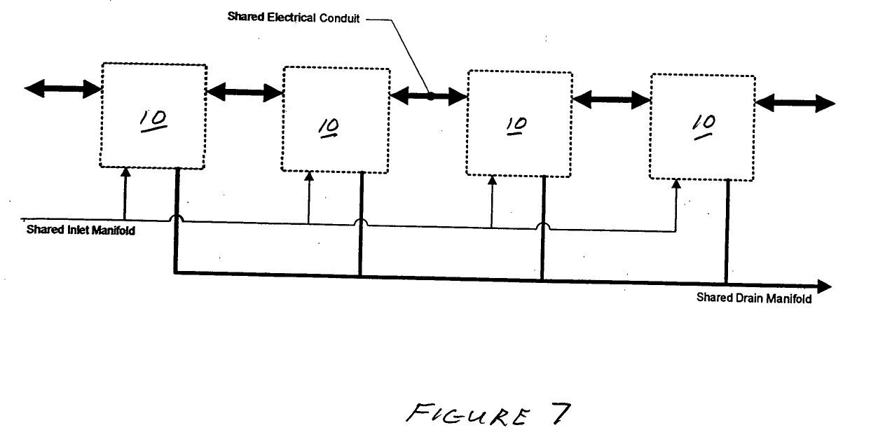

Housings of the invention are designed to be directly embedded in concrete or other paving materials, and the scope of the invention includes structural features to facilitate that placement. The housings may be formed with a curved or geodesic bottom closure 12 to minimize the entrapment of air and the creation of voids below the housing when it is embedded in concrete. As shown in FIG. 6, housings of the invention are also preferably provided with anchor tabs 25, extending outwardly from sidewall 11 at the intersection of the sidewall and the bottom closure. Concrete anchors 26 may be provided as part of the housing system, to be secured in tabs 25 to anchor the housing in concrete paving or paving base. The housing system of the invention may include a water-stop seal to be disposed between the housing body and surrounding paving, in order to seal the gap between the housing and surrounding concrete and prevent infiltration of water and avoid undermining of the concrete around each housing.

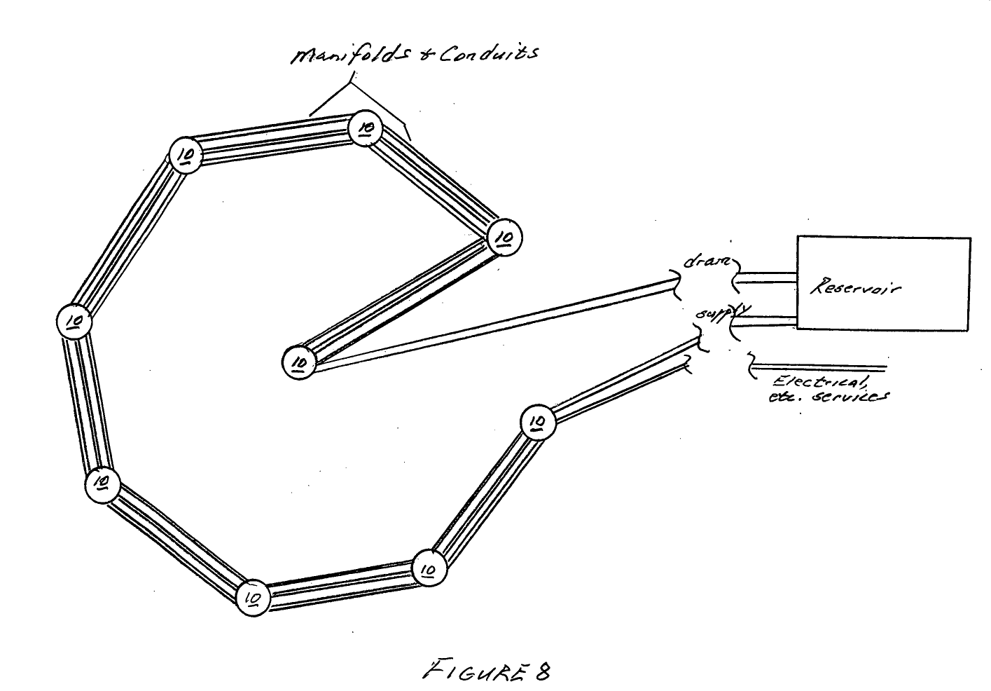

The modular, multi-purpose housings of the invention, by allowing the integration of fountain elements, support a method of highly efficient and cost effective fountain design and installation. FIGS. 7 and 8 schematically illustrate a fountain layout in accordance with the invention and demonstrate the installation efficiencies that can be achieved. FIG. 7 shows an array of housings with shared electrical conduit, shared inlet manifold (for water supply), and shared drain manifold (for water return). A schematic plan view of a simple fountain layout is illustrated in FIG. 8, which also illustrates the shared conduits and manifolds, and a remote holding tank or basin for water that circulates through the fountain system. The layout in FIG. 8 is purely illustrative, and is not to be taken as limiting the variety of layouts and connection schemes that may be used. The sharing of conduit and manifolds enabled by the system of the invention allows all conduit and manifold piping to be run in a single trench, if below grade, or in consolidated lines within a concrete slab, rather than in separate, independent runs as is usually the case in a conventional fountain installation. The use of a remote reservoir for water supply, in contrast to a basin underlying the fountain area, not only simplifies fountain installation, but allows access to the reservoir for maintenance, etc., without disturbing the fountain area. In combination, the modular housings of the invention and the consolidation of service lines enabled by their use, greatly simplifies fountain installation, saving time and money in the design and installation phases, as well as saving time and money by facilitating post-installation maintenance, modification, and expansion.

The foregoing description and illustration of preferred and certain alternative embodiments and variations of the modular housing system of the invention and of methods of fountain installation is intended to be illustrative and not for purposes of limitation. It will be understood that other variations in and alternative embodiments of the housing system of the invention and methods of use may be devised within the scope of the invention, which is intended to be broadly construed.

1. A multi-function fountain housing for use in a dry basin decorative fountain system, for additively and interchangeably receiving a variety of fountain elements including fountain water effect jets, water drains, water valves, light fixtures, electrical connection boxes, and sound speakers, individually or in various combinations, comprising,
a housing body having a hollow interior and an upper end and a lower end, a continuous sidewall with an upper edge and a lower edge, surrounding said hollow interior, a bottom closure connected to said lower edge of said sidewall to close said lower end of said body, said body including a water supply aperture to receive a water supply conduit therethrough from the exterior of said body to said interior of said body, said body including a drain aperture for connection of a drain conduit to drain water from said interior of said body to said exterior of said body, and said body including an electrical aperture to receive electrical lines therethrough from said exterior of said body to said interior of said body.

2. The multi-function fountain housing of claim 1, wherein said housing body further includes an electrical junction box disposed in said interior of said body, said electrical junction box having a nipple extending through said electrical aperture to said exterior of said sidewall.

3. The multi-function fountain housing of claim 1, wherein said housing body further includes an electrical junction box extending partially through said electrical aperture in said body and connected to said body with a portion of said electrical junction box disposed in said interior of said body and a portion of said electrical junction box disposed exterior to said body.

4. The multi-function fountain housing of claim 1, further including a cover to be removably connected to said upper end of said sidewall for closing said body at said upper end thereof, said cover including openings for the flow of water into said interior of said body through said cover.

5. The multi-function fountain housing of claim 1, further including a water supply nipple extending through said water supply aperture and connected to said body, said water supply nipple to be connected to a water supply line for conveying water from a water reservoir to said interior of said body, and a drain nipple extending through said drain aperture and connected to said body for conveying water from said interior of said body, said drain nipple to be connected to a drain line for conveying water to the water reservoir from which water is conveyed to said interior of said body.

6. The multi-function fountain housing of claim 1, wherein said water supply aperture and said drain aperture are formed in said bottom closure, and wherein said electrical aperture is formed in said sidewall.

7. the multi-function fountain housing of claim 1, wherein said water supply aperture, said drain aperture, and said electrical aperture are formed in said bottom closure.

8. The multi-function fountain housing of claim 1, further comprising,
a housing extension having a hollow interior and an upper end and a lower end, a continuous sidewall with an upper edge and a lower edge, surrounding said hollow interior, a bottom lip connected to said lower edge of said sidewall and extending inwardly from said sidewall generally perpendicular thereto into said interior of said housing extension, and an annular upper lip with an upper face and a lower face extending around said upper end of said sidewall, said housing extension received around and extending upwardly from said upper end of said body with said annular lip of said body received upon and connected to said upper face of said bottom lip of said housing extension.

9. A multi-function fountain element for use in a multiple feature fountain system, comprising,
a housing having a hollow interior and an open upper end and a lower end, a continuous sidewall with an upper edge and a lower edge surrounding said hollow interior, a bottom closure connected to said lower edge of said sidewall to close said lower end of said housing, said housing including a water supply nipple extending through a water supply aperture to form a water supply passageway from the exterior of said housing to said interior of said housing, said housing including a drain nipple extending through a drain aperture to form a water drain passageway to carry water from said interior of said housing to said exterior of said housing, and said housing including an electrical junction box with a hollow interior disposed and connected in said interior of said housing and an electrical nipple extending from said junction box through an electrical aperture to form a passageway for electrical lines from said exterior of said housing to said interior of said junction box disposed in said housing;
a water jet assembly disposed in said interior of said housing and connected to said water supply nipple, said water jet assembly having a water outlet for directing a jet of water outwardly from said housing through said open upper end thereof; and
an electrically activated fountain feature assembly disposed in said interior of said housing and connected within said junction box to electrical lines extending into said junction box from said exterior of said housing.

10. The multi-function fountain element of claim 9, wherein said electrically activated fountain feature assembly is a lighting feature for emitting visible light outwardly from said housing through said open end thereof to illuminate water directed outwardly from said housing by said water jet assembly.

11. The multi-function fountain element of claim 9, wherein said electrically activated fountain feature assembly is an audio speaker for emitting sound outwardly from said housing through said open end thereof.

12. The multi-function fountain element of claim 9, wherein said water jet assembly includes a water outlet nozzle and an electrically activated sequencing valve for controlling the flow of water from said water supply nipple to said water outlet nozzle, and wherein said electrically activated fountain feature includes said sequencing valve.

13. The multi-function fountain element of claim 12, wherein said electrically activated fountain feature further includes a lighting feature for emitting visible light outwardly from said housing through said open end thereof.

14. The multi-function fountain element of claim 13, wherein said electrically activated fountain feature further includes an audio speaker for emitting sound outwardly from said housing through said open end thereof.

15. The multi-function fountain element of claim 9, further comprising a cover removably connected to said upper end of said housing, said cover including apertures for the flow of water outwardly from said water jet assembly through said cover and for the flow of water into said housing through said cover.

16. The multi-function fountain element of claim 9, wherein said housing includes an upper housing body having a hollow interior, an open upper end, a substantially open lower end, and a sidewall, and a lower housing body having a hollow interior, an open upper end, a closed lower end, and a sidewall, said lower housing body being of smaller cross-sectional dimension than said upper housing body, said lower housing body connected at said upper end thereof to said lower end of said upper housing body and extending downwardly from said upper housing body, with said hollow interior of said lower housing body in communication with said hollow interior of said upper housing body.

17. A method of installing a multi-element dry basin fountain in a generally horizontal surface for providing water sprays and other decorative fountain features, comprising the steps of
providing, for each fountain element, a housing having a hollow interior and an open upper end and a lower end, a continuous sidewall with an upper edge and a lower edge surrounding said hollow interior, a bottom closure connected to said lower edge of said sidewall to close said lower end of said housing, said housing including a water supply nipple extending through a water supply aperture to form a water supply passageway from the exterior of said housing to said interior of said housing, said housing including a drain nipple extending through a drain aperture to form a water drain passageway to carry water from said interior of said housing to said exterior of said housing, and said housing including an electrical junction box with a hollow interior disposed and connected in said interior of said housing and an electrical nipple extending from said junction box through an electrical aperture to form a passageway for electrical lines from said exterior of said housing to said interior of said junction box disposed in said housing;
removably connecting within said each of said housings a water jet assembly having a water outlet for directing a jet of water outwardly from said housing through said open upper end thereof, and removably connecting said water jet assembly to said water supply nipple within said interior of said housing;
installing a water reservoir below the level of the generally horizontal surface in which the fountain elements are to be installed, with said water reservoir located such that said water reservoir is accessible for maintenance after installation of the fountain without disturbing the fountain elements;
installing water supply lines below the generally horizontal surface between said water reservoir and the location for installation of each of said housings in the generally horizontal surface;
installing water drain lines below the generally horizontal surface between said location for installation of each of said housings and said water reservoir, with said water drain lines adjacent to said water supply lines;
installing electrical lines below the generally horizontal surface between said location for installation of each of said housings and a source for providing and controlling electrical power, with said electrical lines adjacent to said water supply lines and said water drain lines between said locations for installation of said housings;
installing each of said housings in the generally horizontal surface with said upper end of each housing generally flush with the generally horizontal surface such that water will drain by gravity flow into said housings from the generally horizontal surface surrounding each of said housings;
connecting said water supply nipple of each of said housings to said water supply lines at said location of said housing so as to supply water from said water reservoir to each of said housings;
connecting said drain nipple of each of said housings to said water drain lines at said location of said housing so as to drain water from each of said housings to said water reservoir; and
inserting electrical supply lines into said electrical junction box of each of said housings through said electrical nipple so as to maintain electrical circuit continuity through said electrical lines.

18. The method of claim 17, comprising the additional step of removably connecting within selected ones of said housings a lighting assembly for directing visible light outwardly from each of said selected housings through said open upper end thereof, and removably connecting each said lighting assembly to said electrical lines within said junction box in each of said selected housings for providing electrical power to said lighting assembly connected therein.

19. The method of claim 17, wherein said electrical lines include lines carrying audio signals, and comprising the additional step of removably connecting within selected ones of said housings an audio speaker for emitting sound from each of said selected housings through said open upper end thereof, and removably connecting each said audio speaker to said electrical lines carrying audio signals within said junction box in each of said selected housings.

20. The method of claim 17, wherein said electrical lines include lines carrying audio signals, and comprising the additional steps of
removably connecting within selected ones of said housings a lighting assembly for directing visible light outwardly from each of said selected housings through said open upper end thereof, and removably connecting each said lighting assembly to said electrical lines within said junction box in each of said selected housings for providing electrical power to said lighting assembly connected therein; and
removably connecting within selected ones of said housings an audio speaker for emitting sound from each of said selected housings through said open upper end thereof, and removably connecting each said audio speaker to said electrical lines carrying audio signals within said junction box in each of said selected housings.
